(19) United States
(12) Patent Application Publication
(10) Pub. No.: US 2026/0041998 A1
(43) Pub. Date: Feb. 12, 2026

(54) DATA PROCESSING APPARATUS AND METHOD

(71) Applicant: Sony Interactive Entertainment Inc., Tokyo (JP)

(72) Inventors: Ayush RAINA, London (GB); Pierluigi Vito AMADORI, London (GB); Ryan John SPICK, London (GB)

(21) Appl. No.: 19/295,053

(22) Filed: Aug. 8, 2025

(30) Foreign Application Priority Data
Aug. 9, 2024 (GB) 2411774.9

(51) Int. Cl. A63F 13/212; A63F 13/52; G06N 3/092

(52) U.S. Cl. CPC A63F 13/212; A63F 13/52; G06N 3/092

(57) ABSTRACT

A data processing apparatus comprising circuitry configured to: execute a machine learning, ML, model configured to receive, as an input, a game state of a video game and first virtual physiological data indicative of a first virtual physiological state of an agent of the video game, and generate, as an output, a probability of each of a plurality of actions of the agent and second virtual physiological data indicative of a second, subsequent, virtual physiological state of the agent; and perform reinforcement learning to generate a policy for completion of a task by the agent, the reinforcement learning comprising, for each of a plurality of attempts at the task by the agent, executing one or more successive iterations of the ML model and, for each attempt, controlling the agent to perform a different respective set of actions based on the output probability of each of the plurality of actions at each of the one or more successive iterations.

### CROSS-REFERENCE TO RELATED APPLICATIONS

This application claims the benefit of priority to U.K. Application No. 2411774.9, filed on Aug. 9, 2024, the contents of which are hereby incorporated by reference.

### BACKGROUND

### Field of the Disclosure

This disclosure relates to a data processing apparatus and method.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Video games often include artificial intelligence (AI) agents which perform certain tasks or actions in the video game while not being under direct control of a human video game player. For example, non-player characters (NPCs) are computer-controlled characters who engage in combat or competition with or against human-controlled characters to enhance the video game experience.

Various techniques exist for controlling the actions of such agents. In one example, a policy is created which indicates an action the agent should take (as an output) when presented with a particular state of the video game (as an input). Policies may be manually created by a video game designer. Alternatively, machine learning (ML) techniques such as reinforcement learning may be used determine a policy. This involves training an agent to complete a particular task by causing the agent to attempt the task many times and while trying to maximise a reward function associated with the task. The set of game states and actions which maximise the reward function after a certain number of attempts then form the policy.

Techniques such as reinforcement learning can be very effective in training an agent to complete a task. This allows highly competent agents to be coded without the need for many hours of manual game development. However, an agent policy resulting from such machine learning may result in the agent acting in a way which is different to how a human-controlled agent might act. Although this can be beneficial in some circumstances (e.g. it can provide new ways of approaching tasks or problems), in other circumstances it can reduce the realism or believability of such agents. This, in turn, can reduce a human player's immersion in and enjoyment of the video game.

There is therefore a desire to be able to automatically determine video game agent policies which result in more human-like behaviour. Furthermore, it is desirable to achieve this in a computationally efficient way.

### SUMMARY

The present technology is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically shows an example entertainment system;

FIG. 2A schematically shows example components associated with the entertainment system;

FIG. 2B schematically shows an example data processing apparatus;

FIG. 2C schematically shows an example peripheral device;

FIG. 3 schematically shows an example training data format;

FIG. 4 schematically shows an example of training a machine learning model;

FIG. 5 schematically shows an example process for reinforcement learning using the trained machine learning model; and

FIG. 6 shows an example method.

Like reference numerals designate identical or corresponding parts throughout the drawings.

### DETAILED DESCRIPTION OF THE EMBODIMENTS

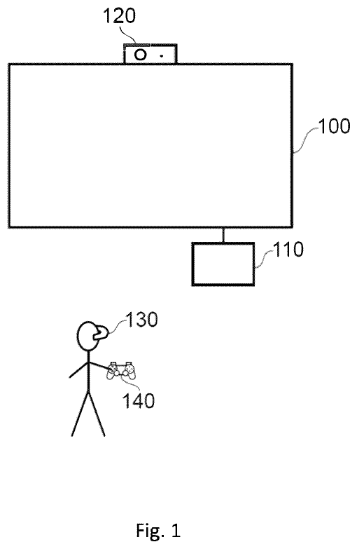

FIG. 1 schematically illustrates an entertainment system suitable for implementing one or more of the embodiments of the present disclosure. Any suitable combination of devices and peripherals may be used to implement embodiments of the present disclosure, rather than being limited only to the configuration shown.

A display device 100 (e.g. a television or monitor), associated with a games console 110, is used to display content to one or more users. A user is someone who interacts with the displayed content, such as a player of a game, or, at least, someone who views the displayed content. A user who views the displayed content without interacting with it may be referred to as a viewer. This content may be a video game, for example, or any other content such as a movie or any other video content. The games console 110 is an example of a content providing device or entertainment device; alternative, or additional, devices may include computers, mobile phones, set-top boxes, and physical media playback devices, for example. In some embodiments the content may be obtained by the display device itself—for instance, via a network connection or a local hard drive.

One or more video and/or audio capture devices (such as the integrated camera and microphone 120) may be provided to capture images and/or audio in the environment of the display device. While shown as a separate unit in FIG. 1, it is considered that such devices may be integrated within one or more other units (such as the display device 100 or the games console 110 in FIG. 1).

In some implementations, an additional or alternative display device such as a head-mountable display (HMD) 130 may be provided. Such a display can be worn on the head of a user, and is operable to provide augmented reality or virtual reality content to a user via a near-eye display screen. A user may be further provided with a video game controller 140 which enables the user to interact with the games console 110. This may be through the provision of buttons, motion sensors, cameras, microphones, and/or any other suitable method of detecting an input from or action by a user.

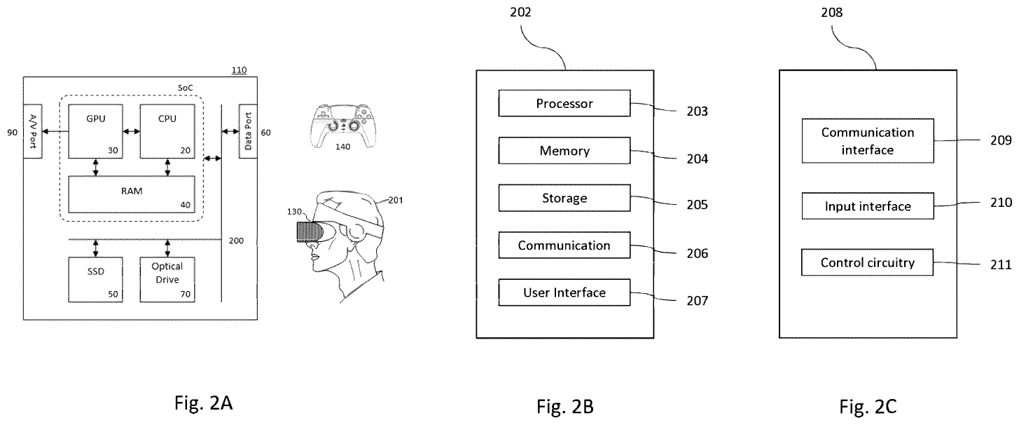

FIG. 2A shows an example of the games console 110. The games console 110 is an example of a data processing apparatus.

The games console 110 comprises a central processing unit or CPU 20. This may be a single or multi core processor, for example comprising eight cores. The games console also comprises a graphical processing unit or GPU 30. The GPU can be physically separate to the CPU, or integrated with the CPU as a system on a chip (SoC).

The games console also comprises random access memory, RAM 40, and may either have separate RAM for each of the CPU and GPU, or shared RAM. The or each RAM can be physically separate, or integrated as part of an SoC. Further storage is provided by a disk 50, either as an external or internal hard drive, or as an external solid state drive (SSD), or an internal SSD.

The games console may transmit or receive data via one or more data ports 60, such as a universal serial bus (USB) port, Ethernet® port, WiFi® port, Bluetooth® port or similar, as appropriate. It may also optionally receive data via an optical drive 70.

Interaction with the games console is typically provided using one or more instances of the controller 140. In an example, communication between each controller 140 and the games console 110 occurs via the data port(s) 60.

Audio/visual (A/V) outputs from the games console are typically provided through one or more A/V ports 90, or through one or more of the wired or wireless data ports 60. The A/V port(s) 90 may also receive audio/visual signals output by the integrated camera and microphone 120, for example. The microphone is optional and/or may be separate to the camera. Thus, the integrated camera and microphone 120 may instead be a camera only, with or without a separate microphone. The camera may capture still and/or video images.

Where components are not integrated, they may be connected as appropriate either by a dedicated data link or via a bus 200.

As explained, examples of a device for displaying images output by the game console 110 are the display device 100 and the HMD 130. The HMD is worn by a user 201. In an example, communication between the display device 100 and the games console 110 occurs via the A/V port(s) 90 and communication between the HMD 130 and the games console 110 occurs via the data port(s) 60.

FIG. 2B shows an example of another data processing apparatus 202 for training AI agents (e.g. NPCs) of video games executed by the games console 110. That is, the data processing apparatus 202 may execute machine learning in the ways described to generate policies for controlling such video game agents. Data indicative of the determined policies is then made available to the games console 110 (e.g. as part of the video game code) when the video game is executed.

Data processing apparatus 202 comprises a processor 203 for executing electronic instructions, a memory 204 (e.g. volatile memory) for storing the electronic instructions to be executed and electronic input and output information associated with the electronic instructions, a storage medium 205 (e.g. non-volatile memory) for long term (persistent) storage of information, a communication interface 206 for sending information to and/or receiving information from one or more other apparatuses and a user interface 207 (e.g. a touch screen, a non-touch screen, buttons, a keyboard and/or a mouse) for receiving commands from and/or outputting information to a user. Each of the processor 203, memory 204, storage medium 205, communication interface 206 and user interface 207 are implemented using appropriate circuitry, for example. The processor 203 controls the operation of each of the memory 204, storage medium 205, communication interface 206 and user interface 207.

FIG. 2C shows some example components of a peripheral device 208 for detecting physiological information from a user. The peripheral device 208 comprises a communication interface 209 for transmitting wireless signals to and/or receiving wireless signals from one or more other apparatuses and a physiological information input interface 210 for detecting physiological information from the user. The communication interface 209 and input interface 210 are controlled by control circuitry 211.

The detected physiological information may be any physiological information indicative of a current state (e.g. psychological state) of the user (e.g. stressed, relaxed, scared, etc.). For example, detected physiological information may include one or more of heart rate, perspiration rate, eye movement, pupil dilation, electrical brain activity or the like. This is a non-exhaustive list and it will be appreciated that other detectable physiological information may be used.

In the below examples, the detected physiological information is heart rate, pupil dilation, perspiration rate and electrical brain activity (with the electrical brain activity being used in a different way to the other physiological information, as will be explained). Each of these may be detected by a separate respective peripheral device 208 (each with an appropriate type of input interface 210) or by a single peripheral device 208 (with a plurality of input interfaces each configured to detect a respective one of heart rate, pupil dilation and perspiration rate).

Heart rate (in beats per minute, bpm) may be detected by a photoplethysmogram (PPG) sensor as the input interface 210, for example.

Pupil dilation (e.g. measured as an area relative to that of the iris of the eye) may be detected by an image sensor as the input interface 210. The image sensor is configured to capture images of an eye of the user. In an example, the image sensor may be comprised within camera 120 or within HMD 130. In this case, the camera 120 or HMD 130 act as a peripheral device 208.

Perspiration rate (e.g. measured in grams per minute per metre squared, g/min m²) may be detected by a fluorescence sensor, colorimetric sensor or electrochemical sensor as the input interface 210, for example.

Brain activity may be detected using a plurality of electroencephalogram (EEG) electrodes as the input interface 210. Each electrode is connected to the user's head and is configured to measure a voltage (at an order of microvolts, μV) indicative of the user's brain activity.

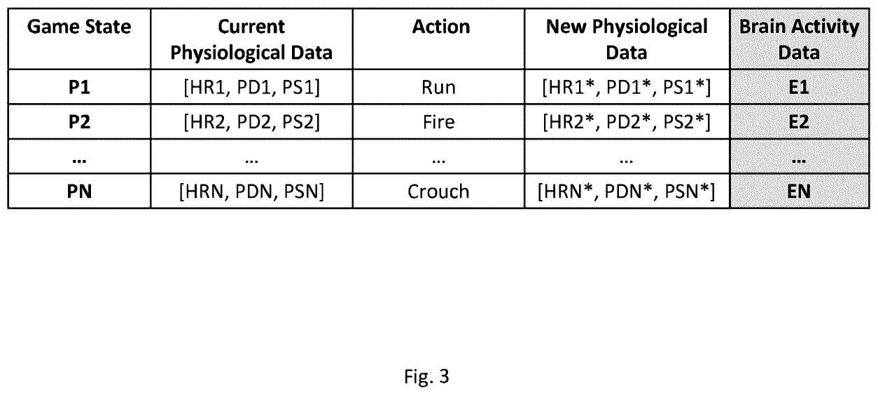

The games console 110, data processing apparatus 202 and peripheral device(s) 208 communicate with each other via the data port(s) 60, communication interface 206 and communication interface 209, respectively. For example, they may communicate with each other over a communications network such as a local area network or the internet. To enable the data processing apparatus 202 to train an AI agent, a human user plays a video game on the games console 110 while allowing physiological information about them (in particular, their heart rate, pupil dilation, perspiration rate and brain activity, in this example) to be detected by the peripheral device(s) 208. Information indicative of the current state of the game (e.g. pixel data of the current output video frame of the video game) and an in-game action executed by the user while the game is in this current state is transmitted from the games console 110 to the data processing apparatus 202. The physiological information detected by the peripheral device(s) 208 is also transmitted to the data processing apparatus 202. This results in the collection of a set of training data like that exemplified in FIG. 3.

As shown in FIG. 3, the training data includes a game state, current physiological data, an action, new physiological data and brain activity. N samples (where N=10000, 20000, 50000 or 100000, for example) of training data are recorded. Each row in FIG. 3 corresponds to one sample of training data. In an example, a sample of training data is recorded each time the user issues a command to control an agent in the video game to perform one of a plurality of predetermined actions. For example, if a user is controlling a character in first person shooter (FPS) video game, a training data sample may be recorded each time the user fires their weapon, each time they run and each time they crouch. On the other hand, if the user is controlling a car in a racing video game, a training data sample may be recorded each time the user turns left, each time they turn right, each time they accelerate and each time they brake. The training data set may comprise training data samples from one or more different users and/or from one or more different games (e.g. games of the same type with the same actions).

The game state information is a matrix Pn (where n=1 to N) representing pixel data of the video frame currently output by the video game. To reduce the amount of processing required, the resolution of the video frame may be reduced (e.g. from 1920×1080 pixels to 192×108 pixels). The pixel data indicates a pixel value (e.g. pixel luma component) of each pixel, for example (with each element of the matrix corresponding to the pixel value of a different respective pixel).

The current physiological data is the current measured heart rate HRn, pupil dilation PDn and perspiration rate PSn of the user (where n=1 to N).

The action is the one of the predetermined actions which causes the sample to be recorded. In the example of FIG. 3, the video game is a FPS and there are three actions (“Fire”, “Run” and “Crouch”) which cause a sample to be recorded. In an example, each of the actions is denoted with a respective one-hot encoded vector. It is noted only three actions are indicated here for ease of explanation. In reality, a much larger number of actions may be recorded, particularly for highly immersive and complex video games.

The new physiological data is the measured heart rate HRn*, pupil dilation PDn* and perspiration rate PSn* of the user (where n=1 to N) a predetermined time period (e.g. 1, 3, 5 or 10 seconds) after (that is, subsequent to) occurrence of the action which causes the sample to be recorded. The new physiological data thus indicates a change in physiological state of the user in response to experiencing a particular game state which causes them to perform an action. The physiological data defines a physiological state of the user.

The brain activity data is EEG data collected from the user over a predetermined time period (e.g. the predetermined time period from the recording of the current physiological data to the recording of the new physiological data). The EEG data of each sample is in the form of a vector En (where n=1 to N) indicating an EEG measurement from each EEG electrode in contact with the user's head (so each element of the vector corresponds to the EEG measurement of a different respective EEG electrode). Any appropriate EEG measurement may be recorded. In an example, a Fast Fourier Transform is performed on the output of each EEG electrode and the amplitude of the lowest frequency component is recorded.

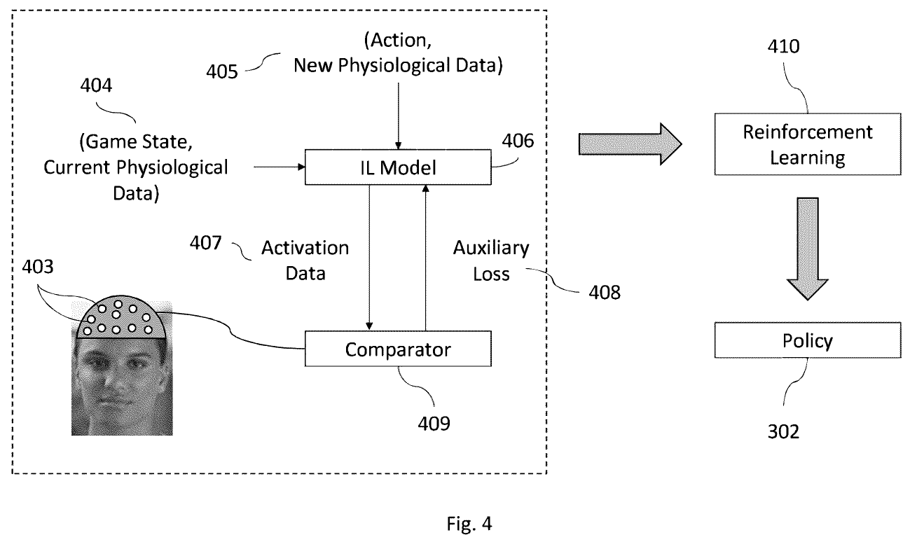

FIG. 4 shows an example of training a machine learning model to generate a policy for controlling AI agents based on the training data of FIG. 3. The training comprises a plurality of stages.

Firstly, an imitation learning (IL) model 406 is trained using the game state and current physiological data (first physiological data) as independent variables 404 and the action and new physiological data (second physiological data) as dependent variables 405. Any suitable IL model may be used.

In an example, a convolutional neural network (CNN) is used as the IL model. The CNN comprises one or more sets of convolutional, ReLu and pooling layers for feature mapping followed by a flattening layer which provides a first portion of an input to a fully connected artificial neural network (ANN). The current physiological data HRn, PDn and PSn forms a second portion of the ANN input. Thus, for example, the input layer of the ANN comprises a plurality of input nodes in which a first portion of the input nodes are mapped to the output of the flattening layer and a remaining, second portion of the input nodes are respectively mapped to HRn, PDn and PSn.

A softmax function is applied to the values of a first portion of the ANN output layer indicating the action. A second portion of the ANN output layer indicates the new physiological data HRn*, PDn* and PSn*. Thus, for example, the output layer of the ANN comprises a plurality of output nodes in which a first portion of the nodes indicate the action (e.g. using an output probabilistic distribution which can be matched to the closest one-hot encoded action vector, the probabilistic distribution being a vector indicating a respective probability associated with each possible action) and a remaining, second portion of the nodes respectively output HRn*, PDn* and PSn*.

The described example network architecture may be used with any training data set (with the number of input and output nodes of the ANN being adjusted depending on the number of physiological data parameters, for example). However, it will be appreciated the skilled person may adjust particular aspects of the architecture depending on, for example, the type of video game, the physiological information which is acquired from the user, etc. to obtain optimal performance. For instance, the number of sets of convolutional, ReLu and pooling layers of the CNN may be adjusted and/or the number of hidden layers in the fully connected ANN may be adjusted. In an example, there are three sets of convolutional, ReLu and pooling layers and two hidden layers in the fully connected ANN.

The IL model 406 is initially trained using backpropagation. For example, stochastic gradient descent over one or more epochs of the training data may be used. This provides an initial set of ML parameters (e.g. weights and biases) of the CNN.

Once the initial training is complete, the training moves onto the second stage. In the second stage, activation data 407 of the IL model is compared with the brain activity data and used as an auxiliary loss function in further backpropagation of the CNN. The activation data is the output of the activation function of each node of the CNN (e.g. each node of the input and any hidden layers of the ANN) for a given sample of the training data. Comparing the activation data and brain activity data helps to optimise the ML parameters of the ANN more quickly (e.g. using fewer epochs over the training data overall) by taking into account the brain activity of the user when they decide to take a particular action in response to a particular game state.

In an example, for each sample of training data, the output of the activation function of each node of the CNN (which may be referred to as the “activation” of that node) is encoded using an autoencoder so it is represented by a vector with the same number of elements as En (which, in turn, corresponds to the number of EEG electrodes 403 attached to the head of the user). For example, after initial training of the IL model 406, the autoencoder is trained using the ANN node activations resulting from each set of independent variables 404 of the training data.

Once the autoencoder is trained, for each set of independent variables for each training data sample, the ANN activations are input to the autoencoder. In an example, ReLu followed by softmax is applied to the encoding of the autoencoder to generate a first probability distribution and softmax is applied to the elements of En associated with the training data sample to generate a second probability distribution. Comparator 409 then compares the first and second probability distributions. The comparator computes, for example, the Kullback-Leibler (KL) divergence between the probability distributions. The calculated KL divergence is used as an auxiliary loss 407 for performing further backpropagation of the ANN. Again, stochastic gradient descent may be used with the auxiliary loss over one or more epochs of the training data.

Although the CNN activations are encoded using an autoencoder in the above example, the present technology is not limited to this and any appropriate encoding technique for allowing the CNN activations to be represented by an appropriate vector (in particular, a vector with the same number of elements as En) may be used. For example, a standardised encoder (e.g. encoder ANN with predetermined weights and/or biases) or an autoregressive autoencoder may be used.

Using both the first stage (initial training of IL model using the training data without the brain activity data) and second stage (further training of the IL model by comparing the ANN activations and brain activity data), the overall number of epochs for training the IL model to imitate human behaviour may be reduced.

The second stage of IL model training is optional and thus the first stage only may be used to train the IL model if no brain activity data is available. In this case, a larger number of training epochs may be required. However, the other technical benefits of the present technology (e.g. improved realism and believability of AI agents) are nonetheless maintained.

Once the further training of the IL model has been completed, reinforcement learning 410 is applied to generate a policy 302 using the output of the trained IL model to guide the choices of the reinforcement learning. Thus, for example, an AI agent is presented with an in-game task and completion of that task is associated with a reward function. As the AI progresses through the task, the reward function increases correspondingly. The concept of reinforcement learning is known and thus not discussed in detail. However, it is noted that conventional reinforcement learning is typically unguided. That is, an agent may take any possible action in the context of a particular game state. This leads to reinforcement learning which is highly computationally expensive and which, even if successful, results in AI agents approaching tasks in ways which human players would not. With the present technology, on the other hand, the trained IL model 406 is used to determine which action(s) would most likely be carried out by a human user given a particular game state and current physiological data.

For example, given a particular game state and current physiological data (which is, for example, initially configured as a set of default values), the softmax-applied output of the ANN indicating the action will be a vector indicating a probability distribution of the possible actions. The agent is controlled to perform only actions satisfying predetermined probability criteria during the reinforcement learning. For example, only actions associated with a probability greater than a predetermined probability threshold (e.g. greater than 0.2) and/or only a predetermined subset of the actions associated with the highest probabilities (e.g. the actions associated with the top three probabilities, assuming there are more than three possible actions) may be performed.

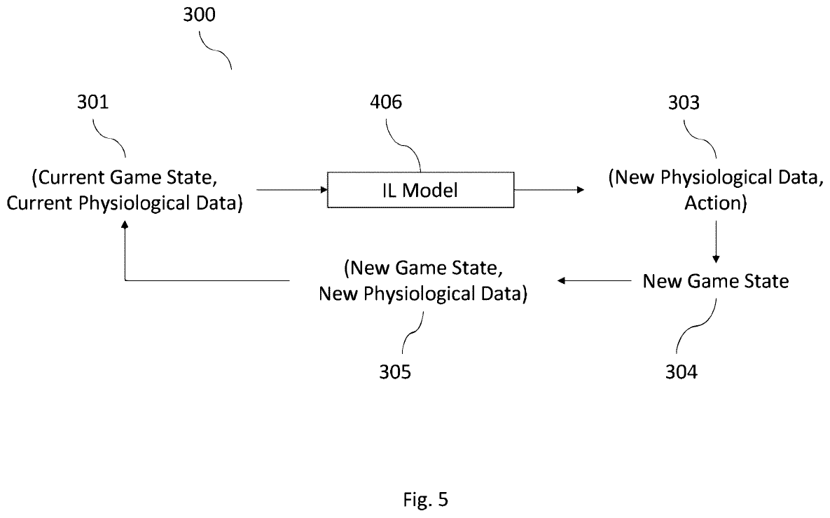

FIG. 5 shows an example process 300 for reinforcement learning using the trained IL model 406.

The current game state and current physiological data of the AI agent are provided as an input 301 to the model. It will be appreciated the AI agent is not associated with a real physiological state (since it is a digital rather than physical entity). Rather, the current physiological data (e.g. heart rate, pupil dilation and perspiration rate) is indicative of a first virtual physiological state of the AI agent. The current physiological data is set to default value(s) at the start of each attempt to complete the task during the reinforcement learning, for example. The current physiological data may be referred to as first virtual physiological data.

As an output 303, IL model 406 provides new physiological data (which defines a second virtual physiological state of the AI agent subsequent to the first virtual physiological state) and an action to be performed. The new physiological data may be referred to as second virtual physiological data.

The AI agent is controlled to complete the action and, as a consequence, the game state is changed to a new game state 304. This is because the agent performing the action (e.g. running, firing a weapon, crouching, etc.) will result in an occurrence in the game and, hence, a change to the game state as defined by the current output video frame of the game.

This allows a new input 305 to the IL model 406 comprising the new game state and new physiological data to be generated.

The process 300 is repeated for successive actions generated by the IL model 406 and carried out by the agent in an attempt to complete the task. Each repeat of the process 300 during a single attempt at the task may be referred to as an iteration. Thus, for successive iterations, the input of the current iteration is generated based on the output of the preceding iteration. The extent to which the task is completed (and, optionally, other attributes such as the speed at which the task is completed and/or how well the task is completed) during the attempt is indicated by the reward function.

The action indicated by the output 303 of the IL model 406 at each iteration is one of the plurality of actions determined based on the softmax generated probability distribution of the ANN output and predetermined probability criteria. A plurality of attempts is made to complete the task. Each attempt starts from the same initial game state and physiological data (e.g. predetermined default physiological data) but uses a different combination of actions. That is, for each attempt at the task by the AI agent, one or more successive iterations of the ML model are executed and, for each attempt, the AI agent is controlled to perform a different respective set of actions based on the output probability of each of the plurality of actions at each of the one or more successive iterations. In particular, the actions available to be executed are constrained by the predetermined probability criteria.

For example, if the predetermined probability criteria is that the actions associated with the three highest softmax probabilities are to be performed, then a first attempt may be defined by performing the action associated with the highest softmax probability at each iteration.

A second attempt may be defined by performing the action associated with the highest softmax probability at each iteration except the final iteration. At the final iteration, the action associated with the second highest softmax probability is performed.

A third attempt may be defined by performing the action associated with the highest softmax probability at each iteration except the final iteration. At the final iteration, the action associated with the third highest softmax probability is performed.

A fourth attempt may be defined by performing the action associated with the highest softmax probability at each iteration except the final two iterations. At the final two iterations, the actions associated with the second highest softmax probability are performed.

A fifth attempt may be defined by performing the action associated with the highest softmax probability at each iteration except the final two iterations. At the final two iterations, the actions associated with the second and third highest softmax probabilities, respectively, are performed.

A sixth attempt may be defined by performing the action associated with the highest softmax probability at each iteration except the final two iterations. At the final two iterations, the actions associated with the third and second highest softmax probabilities, respectively, are performed.

A seventh attempt may be defined by performing the action associated with the highest softmax probability at each iteration except the final two iterations. At the final two iterations, the actions associated with the third highest softmax probabilities are performed.

This process is repeated over all combinations of sequential actions satisfying the predetermined probability criteria. Each attempt is thus defined by a unique sequence of actions.

In an example, for each attempt, the reward function is determined and the game states and associated actions of the most successful attempt (e.g. the attempt resulting in the highest value of the reward function) are stored as a policy for AI agents in the video game attempting the task in the future. The policy 302 is stored as part of the video game code executed by the games console 110, for example. The policy indicates an action the agent should take (as an output) when presented with a particular game state (as an input).

Through use of the predetermined probability criteria and IL model 406, the present technology thus enables the potential number of actions that may be executed by the AI agent at each iteration during reinforcement learning to be reduced, thereby helping reduce the computational burden of the reinforcement learning overall. Furthermore, since the IL model 406 is trained on training data generated from human user(s), the actions executed by the AI agent will be more likely to correspond with those carried out by a human player. The realism and believability of the AI agent's behaviour is therefore improved.

In an example, the new physiological data generated with the action at each iteration of the attempt used to generate the policy 302 may also be stored as part of the policy 302. This allows one or more in-game characteristics of an AI agent to be adjusted depending on how the physiological parameters change over time. For example, if the heart rate, pupil dilation and/or perspiration rate increase as the agent performs actions to complete a task according to the policy (indicating increased stress), the AI agent may be controlled to have a more distressed facial expression, increased pupil size and appear to perspire more. On the other hand, if the heart rate, pupil dilation and/or perspiration rate decrease as the agent performs actions to complete the task according to the policy (indicating reduced stress), the AI agent may be controlled to have a more relaxed facial expression, reduced pupil size and appear to perspire less. This further helps improve the believability of AI agents.

In an example, the present technology may be used by video game developers to test new in-game characteristics (e.g. game levels or in-game environments) to see their likely effect on a user via the physiological data generated by an AI agent as they attempt to complete a task in the game using a policy 302. For instance, an AI agent trained using the present technology may be placed in a new game environment and the physiological data generated as they attempt to complete the task may be used to determine whether the new game environment is likely to cause too much stress to a user (e.g. as indicated by heart rate, pupil dilation and/or perspiration rate increasing by more than a respective predetermined threshold) or be too boring for a user (e.g. as indicated by heart rate, pupil dilation and/or perspiration rate decreasing by more than a respective predetermined threshold). Using an AI agent in this way helps alleviate the need for human testers and the gameplay can be sped up beyond that which would be acceptable to a human player, thereby helping reduce the testing cost and time of game testing.

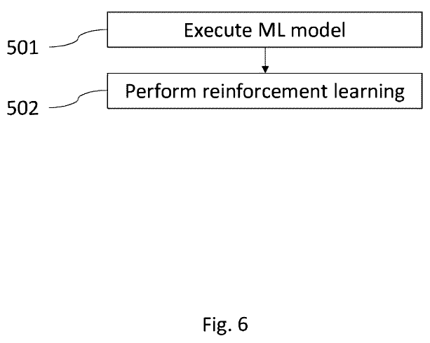

FIG. 6 shows an example method. The method is executed by the processor 203 of data processing apparatus 202, for example.

At step 501, a machine learning, ML, model is executed. The ML model is configured to receive, as an input, a game state of a video game and first virtual physiological data indicative of a first virtual physiological state of an agent of the video game. The ML model is configured to generate, as an output, a probability of each of a plurality of actions of the agent and second virtual physiological data indicative of a second, subsequent, virtual physiological state of the agent.

At step 502, reinforcement learning is performed to generate a policy for completion of a task by the agent. The reinforcement learning comprises, for each of a plurality of attempts at the task by the agent, executing one or more successive iterations of the ML model. For each attempt, the agent is controlled to perform a different respective set of actions based on the output probability of each of the plurality of actions at each of the one or more successive iterations.

Example(s) of the present technique are defined by the following numbered clauses:
1. A data processing apparatus comprising circuitry configured to:
   execute a machine learning, ML, model configured to receive, as an input, a game state of a video game and first virtual physiological data indicative of a first virtual physiological state of an agent of the video game, and generate, as an output, a probability of each of a plurality of actions of the agent and second virtual physiological data indicative of a second, subsequent, virtual physiological state of the agent; and
   perform reinforcement learning to generate a policy for completion of a task by the agent, the reinforcement learning comprising, for each of a plurality of attempts at the task by the agent, executing one or more successive iterations of the ML model and, for each attempt, controlling the agent to perform a different respective set of actions based on the output probability of each of the plurality of actions at each of the one or more successive iterations.
2. A data processing apparatus according to clause 1, wherein, for successively executed iterations of the ML model, an input game state of a current iteration is determined by controlling the agent to perform an action of the plurality of actions based on the output probability of the action of a preceding iteration, and input first virtual physiological data of the current iteration corresponds to output second virtual physiological data of the preceding iteration.
3. A data processing apparatus according to any preceding clause, wherein, for each of the plurality of attempts, each action in the performed set of actions is an action associated with an output probability greater than a predetermined probability threshold.
4. A data processing apparatus according to any preceding clause, wherein, for each of the plurality of attempts, each action in the performed set of actions is one of a subset of the plurality of actions associated with one or more highest output probabilities.
5. A data processing apparatus according to any preceding clause, wherein the ML model has been trained using training data comprising a plurality of training data samples, each training data sample comprising, as independent variables, a game state of a video game and first physiological data of a user playing the video game, and, as dependent variables, an action in the video game instructed by the user and second, subsequent, physiological data of the user.
6. A data processing apparatus according to clause 5, wherein the ML model comprises an artificial neural network, ANN.
7. A data processing apparatus according to clause 6, wherein the ML model has been further trained using an auxiliary loss representing a difference in activation function output of the ML model and measured electrical brain activity of the user for each training data sample.
8. A data processing apparatus according to clause 7, wherein the measured electrical brain activity is a set of electroencephalogram, EEG, measurements of the user.
9. A data processing apparatus according to clause 8, wherein the activation function output is represented by a first probability distribution and the set of EEG measurements of the user is represented by a second probability distribution
10. A data processing apparatus according to clause 9, wherein the difference is a Kullback-Leibler, KL, divergence between the first and second probability distributions.
11. A data processing apparatus according to any one of clauses 5 to 10 wherein the first and second physiological data of the user comprises one or more of heart rate, perspiration rate, pupil dilation, eye movement and electrical brain activity.
12. A data processing apparatus according to any preceding clause, wherein the game state comprises pixel data of an output video frame of the video game.
13. A computer-implemented data processing method comprising:
   executing a machine learning, ML, model configured to receive, as an input, a game state of a video game and first virtual physiological data indicative of a first virtual physiological state of an agent of the video game, and generate, as an output, a probability of each of a plurality of actions of the agent and second virtual physiological data indicative of a second, subsequent, virtual physiological state of the agent; and
   performing reinforcement learning to generate a policy for completion of a task by the agent, the reinforcement learning comprising, for each of a plurality of attempts at the task by the agent, executing one or more successive iterations of the ML model and, for each attempt, controlling the agent to perform a different respective set of actions based on the output probability of each of the plurality of actions at each of the one or more successive iterations.
14. A program for controlling a computer to perform a method according to clause 13.
15. A computer-readable storage medium storing a program according to clause 14.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A computer-implemented data processing method comprising:
executing a machine learning, ML, model configured to:
receive, as an input, a game state of a video game and first virtual physiological data indicative of a first virtual physiological state of an agent of the video game, and
generate, as an output, a probability of each of a plurality of actions of the agent and second virtual physiological data indicative of a second, subsequent, virtual physiological state of the agent; and
performing reinforcement learning to generate a policy for completion of a task by the agent, the reinforcement learning comprising:
for each of a plurality of attempts at the task by the agent, executing one or more successive iterations of the ML model; and
for each attempt, controlling the agent to perform a different respective set of actions based on the output probability of each of the plurality of actions at each of the one or more successive iterations.

2. The method of claim 1, wherein, for successively executed iterations of the ML model, an input game state of a current iteration is determined by controlling the agent to perform an action of the plurality of actions based on the output probability of the action of a preceding iteration, and input first virtual physiological data of the current iteration corresponds to output second virtual physiological data of the preceding iteration.

3. The method of claim 1, wherein, for each of the plurality of attempts, each action in the performed set of actions is an action associated with an output probability greater than a predetermined probability threshold.

4. The method of claim 1, wherein, for each of the plurality of attempts, each action in the performed set of actions is one of a subset of the plurality of actions associated with one or more highest output probabilities.

5. The method of claim 1, wherein the ML model has been trained using training data comprising a plurality of training data samples, each training data sample comprising, as independent variables, a game state of a video game and first physiological data of a user playing the video game, and, as dependent variables, an action in the video game instructed by the user and second, subsequent, physiological data of the user.

6. The method of claim 5, wherein the ML model comprises an artificial neural network, ANN.

7. The method of claim 6, wherein the ML model has been further trained using an auxiliary loss representing a difference in activation function output of the ML model and measured electrical brain activity of the user for each training data sample.

8. The method of claim 7, wherein the measured electrical brain activity is a set of electroencephalogram, EEG, measurements of the user.

9. The method of claim 8, wherein the activation function output is represented by a first probability distribution and the set of EEG measurements of the user is represented by a second probability distribution.

10. The method of claim 9, wherein the difference is a Kullback-Leibler, KL, divergence between the first and second probability distributions.

11. The method of claim 5, wherein the first and second physiological data of the user comprises one or more of heart rate, perspiration rate, pupil dilation, eye movement and electrical brain activity.

12. The method of claim 1, wherein the game state comprises pixel data of an output video frame of the video game.

13. A system comprising:
one or more computers; and
one or more storage devices storing instructions that, when executed by the one or more computers, cause the one or more computers to perform operations comprising:
executing a machine learning, ML, model configured to:
receive, as an input, a game state of a video game and first virtual physiological data indicative of a first virtual physiological state of an agent of the video game, and
generate, as an output, a probability of each of a plurality of actions of the agent and second virtual physiological data indicative of a second, subsequent, virtual physiological state of the agent; and
performing reinforcement learning to generate a policy for completion of a task by the agent, the reinforcement learning comprising:
for each of a plurality of attempts at the task by the agent, executing one or more successive iterations of the ML model; and
for each attempt, controlling the agent to perform a different respective set of actions based on the output probability of each of the plurality of actions at each of the one or more successive iterations.

14. The system of claim 13, wherein, for successively executed iterations of the ML model, an input game state of a current iteration is determined by controlling the agent to perform an action of the plurality of actions based on the output probability of the action of a preceding iteration, and input first virtual physiological data of the current iteration corresponds to output second virtual physiological data of the preceding iteration.

15. The system of claim 13, wherein, for each of the plurality of attempts, each action in the performed set of actions is an action associated with an output probability greater than a predetermined probability threshold.

16. The system of claim 13, wherein, for each of the plurality of attempts, each action in the performed set of actions is one of a subset of the plurality of actions associated with one or more highest output probabilities.

17. One or more non-transitory computer-readable storage media storing instructions that when executed by one or more computers cause the one or more computers to perform operations comprising:
executing a machine learning, ML, model configured to:
receive, as an input, a game state of a video game and first virtual physiological data indicative of a first virtual physiological state of an agent of the video game, and
generate, as an output, a probability of each of a plurality of actions of the agent and second virtual physiological data indicative of a second, subsequent, virtual physiological state of the agent; and
performing reinforcement learning to generate a policy for completion of a task by the agent, the reinforcement learning comprising:
for each of a plurality of attempts at the task by the agent, executing one or more successive iterations of the ML model; and
for each attempt, controlling the agent to perform a different respective set of actions based on the output probability of each of the plurality of actions at each of the one or more successive iterations.

18. The one or more non-transitory computer-readable storage media of claim 17, wherein, for successively executed iterations of the ML model, an input game state of a current iteration is determined by controlling the agent to perform an action of the plurality of actions based on the output probability of the action of a preceding iteration, and input first virtual physiological data of the current iteration corresponds to output second virtual physiological data of the preceding iteration.

19. The one or more non-transitory computer-readable storage media of claim 17, wherein, for each of the plurality of attempts, each action in the performed set of actions is an action associated with an output probability greater than a predetermined probability threshold.

20. The one or more non-transitory computer-readable storage media of claim 17, wherein, for each of the plurality of attempts, each action in the performed set of actions is one of a subset of the plurality of actions associated with one or more highest output probabilities.
